(19) United States
(12) Patent Application Publication
(10) Pub. No.: US 2024/0253285 A1
(43) Pub. Date: Aug. 1, 2024

(54) INJECTION MOLDING ASSISTANCE SYSTEM, INJECTION MOLDING ASSISTANCE METHOD, INJECTION MOLDING MACHINE, AND RECORDING MEDIUM

(71) Applicant: Sodick Co., Ltd., Kanagawa (JP)

(72) Inventor: Yusuke YAMAZAKI, Kanagawa (JP)

(73) Assignee: Sodick Co., Ltd., Kanagawa (JP)

(21) Appl. No.: 18/419,572

(22) Filed: Jan. 23, 2024

(30) Foreign Application Priority Data
Jan. 30, 2023 (JP) 2023-011984

(51) Int. Cl. B29C 45/76

(52) U.S. Cl. CPC B29C 45/768; B29C 2945/76949

(57) ABSTRACT

An injection molding assistance system includes: an information receiving unit, receiving trial molding conditions, article information, and molding defect types; a design variable determination unit, determining a part of molding conditions to be learned as design variables based on the article information and the molding defect types; a learning data generating unit, generating multiple learning data in which the design variables are uniformly distributed in a variable space; a molding control unit, causing the injection molding machine to prototype a molded product according to the trial molding conditions that reflect the learning data; an evaluation receiving unit, receiving an evaluation for the molded product; and a learned data generating unit, generating learned data for molding an article with desired quality by being reflected in the trial molding conditions based at least on the learning data and the evaluation.

### CROSS-REFERENCE TO RELATED APPLICATIONS

This application claims the priority benefit of Japanese patent application serial No. 2023-011984, filed on Jan. 30, 2023. The entirety of the above-mentioned patent application is here by incorporated by reference herein and made a part of this specification.

### BACKGROUND

### Technical Field

The present invention relates to an injection molding machine that injects molten material into a cavity of a metal mold, and particularly to an injection molding assistance system that determines optimal molding conditions.

In general, an operator of an injection molding machine sets optimal molding conditions while repeating test molding in order to obtain a high quality article. For the initial test molding, safe molding conditions are used in which less material is injected into the metal mold to avoid damaging the metal mold. Japanese Patent No. 2671253 and U.S. Pat. No. 6,305,963 disclose setting molding conditions by simple input according to a screen of a display apparatus.

When setting the molding condition, it is also possible to determine the molding conditions by learning such as machine learning. However, when using artificial intelligence, machine learning, deep learning, etc., a large amount of learning data is required. Furthermore, if the shape of the article is changed, it is necessary to collect the learning data again, which requires a lot of time and has low versatility.

In view of the above circumstances, the present invention provides an injection molding assistance system, an injection molding assistance method, an injection molding machine, and a program which may easily determine molding conditions with a relatively small amount of learning data by using human sensory evaluation values.

### SUMMARY

According to one aspect of the present invention, an injection molding assistance system for an injection molding machine controlled according to molding conditions is provided. This injection molding assistance system includes an information receiving unit, receiving molding conditions, article information, and molding defect types; a design variable determination unit, determining a part of molding conditions to be learned as design variables based on the article information and the molding defect types; a learning data generating unit, generating a plurality of learning data in which the design variables are uniformly distributed in a variable space constituted by the design variables; a molding control unit, causing the injection molding machine to prototype an article according to the molding conditions that reflect the learning data; an evaluation receiving unit, receiving an evaluation for the molded product; and a learned data generating unit, generating learned data for molding an article with desired quality by being reflected in the molding conditions based at least on the learning data and the evaluation.

### BRIEF DESCRIPTION OF THE DRAWINGS

FIG. 1 is a block diagram showing the configuration of the injection molding assistance system 1.

FIG. 2 is a block diagram showing the functional configuration of the injection molding assistance system 1.

FIG. 3 is a diagram showing an example of learning data generated by the learning data generating unit 103.

FIG. 4 is a diagram showing an example of the numerical value input field 140 to be presented.

FIG. 5 is a diagram showing an example of the slider bar to be presented.

FIG. 6 is a diagram showing an example of extending the length of the slider bar 150.

FIG. 7 is a diagram showing another example of the numerical value input field 140 to be presented.

FIG. 8 is a diagram showing an example in which the numerical value input field 140 and the slider bar 150 are presented together.

FIG. 9 is an activity diagram showing the operation flow of the injection molding assistance system 1.

FIG. 10 is an activity diagram showing the operation flow of the injection molding assistance system 1.

FIG. 11 is an activity diagram showing the operation flow of the injection molding assistance system 1.

FIG. 12 is an activity diagram showing the operation flow of the injection molding assistance system 1.

FIG. 13 is an activity diagram showing the operation flow of the injection molding assistance system 1.

FIG. 14 is a diagram showing a configuration example of the injection molding machine.

### DESCRIPTION OF THE EMBODIMENTS

Hereinafter, embodiments of the present invention will be described with reference to attached drawings. Various feature items in the embodiments described below may be combined with each other.

In the present embodiment, a program for implementing the software for operating an injection molding assistance system may be offered in the form of a non-transitory computer-readable medium, in a manner downloadable from an external server, or by use of an external computer activating the program to let client terminals implement the functions represented by the program (so-called cloud computing).

In this embodiment, the term “unit” refers to one of the plurality of components that make up the injection molding assistance system 1. Each component is composed of one or more circuit apparatuses in this embodiment. A circuit apparatus is a circuit unit formed by combining multiple electric circuit components such as resistors and electronic circuit components such as AND gates, specifically, the circuit apparatus is an apparatus that is mounted on the main board, referred to as the motherboard, which makes up one computer, e.g., the central processing unit, main memory, and sound system. The circuit apparatus includes machines that is communicatively connected to the motherboard, such as so-called external apparatuses, such as hard disks, flash memory, and monitors. Each component includes, for example, a combination of hardware resources implemented by a circuit in a broad sense and information processing of software that can be concretely implemented by these hardware resources. The present embodiment handles various pieces of information and these pieces of information include digital data and analog data, and are, for example, represented by physical values of signal values indicating voltage and current, the levels of signal values as a bit aggregate of a binary number constituted by 0s or 1s, or quantum superposition (what is called qubits), and communication and calculation thereof can be performed on a circuit in a broad sense.

The circuits in the broad sense are implemented by at least appropriately combining circuits, circuitry, processors, memories, and the like. That is, the circuits include an application-specific integrated circuit (ASIC) and a programmable logic device (e.g., simple programmable logic device (SPLD), complex programmable logic device (CPLD), and a field programmable gate array (FPGA)).

### 1. Configuration of the Injection Molding Assistance System

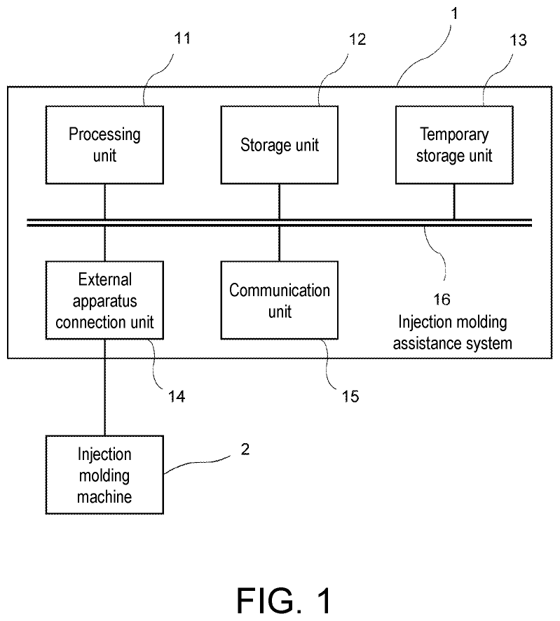

As shown in FIG. 1, the injection molding assistance system 1 comprises a processing unit 11, a storage unit 12, a temporary storage unit 13, an external apparatus connection unit 14, and a communication unit 15, and these components are electrically connected within the injection molding assistance system 1 via a communication bus 16.

The processing unit 11 is implemented by, for example, one or more central processing units (CPUs), operates according to a predetermined program stored in the storage unit 12, and realizes various functions.

The storage unit 12 is a nonvolatile storage medium that stores various information. This is implemented, for example, by a storage device such as a hard disk drive (HDD) or solid state drive (SSD). The storage unit 12 may also be placed in another apparatus that is able to communicate with the injection molding assistance system 1.

The temporary storage unit 13 is a volatile storage medium. This is realized by main memory such as random access memory (RAM), and information (arguments, arrays, etc.) required for temporary when the processing unit 11 performs an operation, alternatively, all or part of the application program being executed is stored.

The external apparatus connection unit 14 is a connection unit conforms to standards such as universal serial bus (USB) and HDMI (registered trademark), for example, it is possible to connect input apparatuses such as a keyboard and display apparatuses such as a monitor. Connection with injection molding machine 2 may also be performed.

The communication unit 15 is, for example, a communication means that conforms to a local area network (LAN) standard and realizes communication between the injection molding assistance system 1 and a local area network or a network such as the Internet via this LAN. Instead of the external apparatus connection unit 14, communication with the injection molding machine 2 may also be performed. When the injection molding machine 2 is connected to the external apparatus connection unit 14, the communication unit 15 may be omitted. A general-purpose server-oriented computer or personal computer may be used for the injection molding assistance system 1, and multiple computers may be used to configure the injection molding assistance system 1.

### 2. Functions of the Injection Molding Assistance System 1

The functions of the injection molding assistance system 1 are described. The injection molding assistance system 1 implements each functional unit described below by performing an operation according to the program. This program is a program that operates the computer as the injection molding assistance system 1. Specifically, each functional unit is realized by the processing unit 11, which is hardware, performing an operation based on a program, that is, software, stored in the storage unit 12. At this time, the processing unit 11 operates the storage unit 12, the temporary storage unit 13, the external apparatus connection unit 14, and the communication unit 15 as needed.

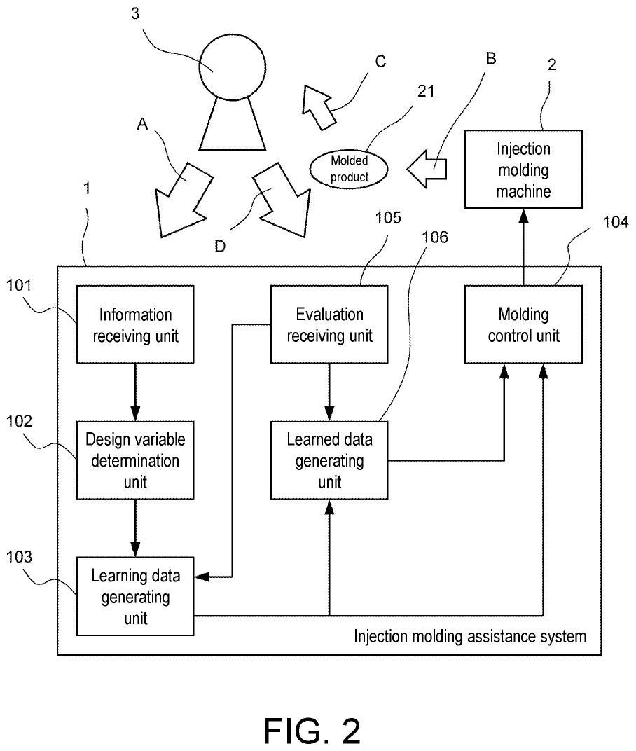

As shown in FIG. 2, the injection molding assistance system 1 includes an information receiving unit 101, a design variable determination unit 102, a learning data generating unit 103, a molding control unit 104, an evaluation receiving unit 105, and a learned data generating unit 106.

The information receiving unit 101 receives trial molding conditions, article information, and molding defect types of the injection molding machine 2 from the operator 3 operating the injection molding machine 2. The arrow A indicates the molding defect type. The trial molding conditions are the molding conditions for a test molding. Using the trial molding conditions, the injection molding machine 2 is able to mold an article, but the trial molding conditions are not yet to the point of molding the article of the desired quality and are molding conditions that have room for modification.

The article information includes, for example, the resin material used to mold the article, the shape and dimensions of the runner, the minimum and maximum thickness of the article, the weight of the resin material to be filled into the cavity, and the pressure at the transition from the injection process to the pressure holding process, commonly known as the VP switch pressure. The shape of the runner is selected from circular, rectangular, and direct gate. A direct gate is a metal mold structure in which the molten resin material is injected directly into the cavity from the sprue, and no runners are formed.

The injection molding machine 2 includes a mold clamping device (not shown) and an injection apparatus (not shown). The mold clamping device opens and closes a metal mold apparatus mounted thereon and clamps the mold. The injection apparatus, for example, heats and melts pelletized thermoplastic resin material, and then injects the measured molten resin into the cavity of the metal mold apparatus. The molding conditions include, for example, resin temperature (also referred to as melting temperature), metal mold temperature, injection speed, pressure holding force (also referred to as holding pressure), pressure holding time (also referred to as holding pressure time), cooling time, mold clamping force (also referred to as mold clamping pressure), mold closing speed, and mold opening speed. The setting data of the molding conditions is not limited to the format of a numerical value in a predetermined unit, such as a temperature value, a pressure value, and a speed value. The setting data may be in the form of choices such as ON and OFF. The operation of the injection molding machine 2 is controlled according to the molding conditions.

The article information and the trial molding conditions received by the information receiving unit 101 may be, by the operator 3, directly input numerically using a display apparatus and an input apparatus or selectively input using the input apparatus from multiple choices displayed on the display apparatus. The input apparatus is, for example, an operation panel, a keyboard, a mouse, or a touch panel. The touch panel is, for example, attached to the display screen of the display apparatus, to enable various buttons and slider bars displayed on the display screen to be operated like physical buttons and slider bars. The article information and the trial molding conditions received by the information receiving unit 101 may be stored in the storage unit 12 in advance and input by reading from the storage unit 12, or may be automatically input as the result of calculations from the data read from the storage unit 12. The molding defect types includes at least one of a warpage, a weld line, a silver streak, a flow mark, jetting, a sink mark, a void, a flash burr, resin burning, a short shot. The operator 3 may use the display apparatus and the input apparatus to selectively input one of the displayed molding defect types.

The design variable determination unit 102 determines a part of molding conditions to be learned as design variables based on the article information and the molding defect types. The design variable determination unit 102 may determine on one molding condition as the design variable or may determine on at least two molding conditions as the design variables, respectively. The number of molding defect types used to determine the design variables may be one or a combination of at least two. The determination of the design variables is performed by referencing tables in the database, and, for example, when the received molding defect type is “sink mark,” six molding conditions, including resin temperature, metal mold temperature, injection speed, pressure holding force, pressure holding time, and cooling time, are respectively determined as the design variables. The number of design variables at this time is six. For example, the table, including the data of the article information and the defect type, and the data of the design variables determined based on the article information and the defect type, may be stored in advance in the storage unit 12 as associated data. The operator may arbitrarily determine the design variables.

The learning data generating unit 103 generates multiple learning data in which the design variables are uniformly distributed in a variable space constituted by the design variables. The learning data generating unit 103 may generate multiple pieces of learning data at once. For example, in the case that there are n design variables, the space between the upper limit value and the lower limit value of each of the design variables in the n-dimensional space becomes the variable space. The learning data generating unit 103 generates the learning data within a range of the upper limit value and the lower limit value of the design variables. The upper limit value and the lower limit value of the design variables are determined by reading data extracted from the data base using a predetermined method or by calculating result using a predetermined calculation formula. For example, in the case that the received molding defect type is “sink mark,” among the six design variables, the upper limit values and the lower limit values of resin temperature, metal mold temperature, and injection speed are determined by reading the data, respectively, extracted from the data base using a predetermined method, and the upper limit values and the lower limit values of pressure holding force, pressure holding time, and cooling time are calculated using predetermined calculation formulas. The number of pieces of learning data to be generated varies depending on the method of generating learning data, but is set automatically or manually.

The learning data generating unit 103 uses, for example, an experimental design method when generating the learning data. Preferably, the learning data generating unit 103 may use, for example, a Latin hypercube (LHD). The Latin hypercube is one of the methods for determining combinations of design variables of learning data such that sample points are uniformly arranged in the design variable space. One sample point indicates one piece of learning data, and for each design variable, there is one piece of data that is a candidate for setting data to be set to a part of the molding conditions determined by the design variable determination unit 102 as the design variables. Thus, in other words, the Latin hypercube is one of the methods that may determine the combination of data that are the candidates for the setting data to be assigned to each design variable for each of the learning data, respectively, so that each learning data is uniformly arranged in that design variable space. Data that is the candidate for the setting data to be assigned to the design variables is, for example, data that is expressed in numerical values. The Latin hypercube efficiently covers combinations of the data that is the candidate for setting data to be assigned to the design variables of the learning data, even with a small number of learning data.

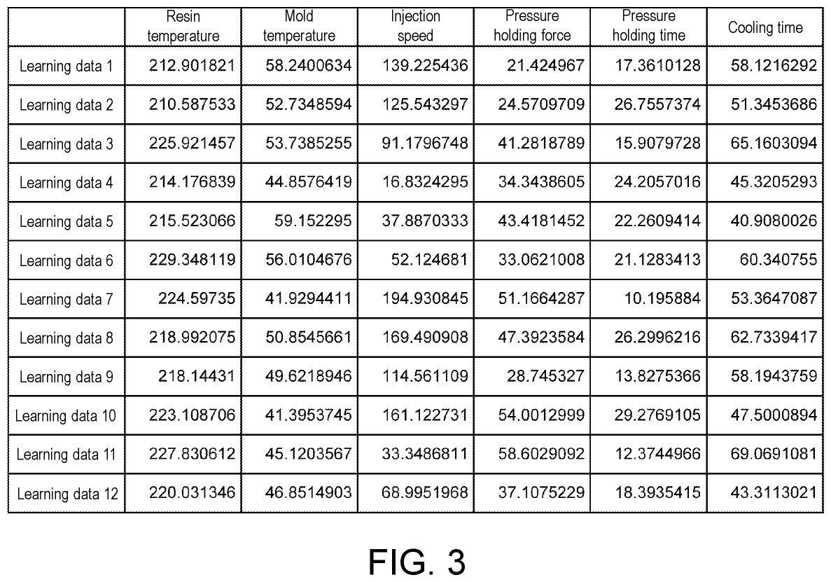

As shown in FIG. 3, the design variable determination unit 102 determines six molding conditions, including resin temperature, metal mold temperature, injection speed, pressure holding force, pressure holding time, and cooling time, as the design variables, respectively. After that, the learning data generating unit 103 generates 12 pieces of learning data from learning data 1 to learning data 12. One piece of learning data shown in FIG. 3 consists of a total of six pieces of data, one for each design variable, which is the candidate for the setting data to be set for each of the six molding conditions. One data that is a candidate for the setting data is, for example, a numerical value.

In the case that the optimal solution is determined by the learned data generating unit 106, the learning data generating unit 103 increases at least the upper limit value of the design variables and regenerates multiple learning data when the optimal solution for which an evaluation received by the evaluation receiving unit 105 satisfies an acceptance standard does not exist and a difference between the optimal solution and the upper limit value of the design variables is less than a predetermined value, and decreases at least the lower limit value of the design variables and regenerates multiple learning data when the optimal solution for which an evaluation received by the evaluation receiving unit 105 satisfies an acceptance standard does not exist and a difference between the optimal solution and the lower limit value of the design variables is less than a predetermined value, and Increasing at least the upper limit value of the design variable is not limited to cases where only the upper limit value of the design variable is increased, but also means that there are cases where the upper limit value of the design variable is increased and the lower limit value of the design variable is decreased. Decreasing at least the lower limit value of the design variable is not limited to cases where only the lower limit value of the design variable is decreased, but also means that there are cases where the upper limit value of the design variable is increased and the lower limit value of the design variable is decreased. Except for changing either one or both of the upper limit value and lower limit value of the design variables, the operation remains the same as when the learning data is initially generated by the learning data generating unit 103; thus, details are omitted.

The molding control unit 104 performs control on the injection molding machine 2 to mold an article for each learning data using the injection molding machine 2 according to the molding conditions that reflect each learning data. Specifically, the molding control unit 104 causes the injection molding machine 2 to prototype a first molded product according to the trial molding conditions received by the information receiving unit 101 and causes the injection molding machine 2 to prototype a second molded product for each learning data according to the molding conditions that reflect each learning data. At this time, the molding control unit 104 causes the injection molding machine 2 to prototype a predetermined number of second molded products before the evaluation receiving unit 105 receives the initial evaluation. Preferably, the molding control unit 104 causes the injection molding machine 2 to prototype at least three second molded products before the evaluation receiving unit 105 receives the initial evaluation. More preferably, the molding control unit 104 causes the injection molding machine 2 to prototype three second molded products before the evaluation receiving unit 105 receives the initial evaluation. The operator 3, for example, when the predetermined number is three, may input evaluations for each of the second molded products from the first to the third into the evaluation receiving unit 105 while comparing the same, allowing for a high-precision evaluation starting from the evaluation for the first second molded product.

When the optimal solution is determined by the learned data generating unit 106, the molding control unit 104 causes the injection molding machine 2 to prototype a second molded product for each optimal solution according to the molding conditions that reflect each optimal solution. When the learning data is regenerated by the learning data generating unit 103, the molding control unit 104 causes the injection molding machine 2 to prototype a second molded product for each regenerated learning data according to the molding conditions that reflect each regenerated learning data. When the optimal solution is redetermined by the learned data generating unit 106, the molding control unit 104 causes the injection molding machine 2 to prototype a second molded product for each optimal solution according to the molding conditions that reflect each redetermined optimal solution. When the learned data is generated by the learned data generating unit 106, the molding control unit 104 causes the injection molding machine 2 to prototype a third molded product according to the molding conditions that reflect the learned data. The third molded product is the article.

The molding conditions that reflect the generated or regenerated learning data are the molding conditions reflected in the trial molding conditions of one piece of the learning data. The trial molding conditions are the molding conditions for test molding in which the setting data is set in advance, respectively. Regarding the molded products prototyped by the injection molding machine 2 according to the trial molding conditions, the desired quality of the operator 3 is not expected.

The molding conditions that reflect the determined or redetermined optimal solution are the molding conditions that reflect one optimal solution in the trial molding conditions described above. That is, the molding conditions that reflect the determined or redetermined optimal solution are the molding conditions generated by replacing, for the predetermined trial molding conditions, only the setting data of a part of the molding conditions that are predetermined to be the design variables with the candidate for that setting data that one optimal solution includes.

The molding conditions that reflect the learned data are the molding conditions that reflect the learned data in the trial molding conditions described above. That is, the molding conditions that reflect the learned data are the final molding conditions generated by replacing, for the predetermined trial molding conditions, only the setting data of a part of the molding conditions that are predetermined to be the design variables with final data of that setting data that the learned data includes. The molded product generated by the injection molding machine 2 according to the molding conditions that reflect the learned data is an article that satisfies the desired quality.

As shown in FIG. 2, the injection molding machine 2 prototypes a molded product 21 for each learning data according to molding conditions that reflect each learning data. The arrow B shows the prototype of the molded product 21 produced by the injection molding machine 2, and the molded product 21 corresponds to the second molded product. The operator 3 evaluates each molded product 21 prototyped by the injection molding machine 2. The arrow C indicates evaluation by the operator 3. The evaluation receiving unit 105 receives the evaluation result for each molded product 21. The arrow D indicates the evaluation result by the operator 3

When the optimal solution is determined by the learned data generating unit 106, the evaluation receiving unit 105 receives the evaluation result obtained by the evaluation by the operator 3 for each molded product 21 that the injection molding machine 2 prototypes for each optimal solution according to the molding conditions that reflect each optimal solution, respectively, that is, the evaluation for each molded product 21. When the learning data is regenerated by the learning data generating unit 103, the evaluation receiving unit 105 receives the evaluation result obtained by the evaluation by the operator 3 for each molded product 21 that the injection molding machine 2 prototypes for each learning data according to the molding conditions that reflect each regenerated learning data, respectively, that is, the evaluation for each molded product 21.

When the optimal solution is redetermined by the learned data generating unit 106, the evaluation receiving unit 105 receives the evaluation result obtained by the evaluation by the operator 3 for each molded product 21 that the injection molding machine 2 prototypes for each optimal solution according to the molding conditions that reflect each redetermined optimal solution, respectively, that is, the evaluation for each molded product 21. The operator 3 evaluates the molded product 21 by hand contact or visual inspection. The molded product 21 may be evaluated by analyzing image data or by actual measurement using a measuring device.

The evaluation receiving unit 105 receives the evaluation for the molded product 21 after the injection molding machine 2 has prototyped a predetermined number of molded products 21, for example, after the injection molding machine 2 has prototyped at least three molded product 21. Preferably, the evaluation receiving unit 105 may receive the evaluation for the molded product 21 after the injection molding machine 2 has prototyped three molded products 21. The evaluation receiving unit 105 receives the evaluation for the molded product 21 each time the injection molding machine 2 prototypes the molded product 21 after an initial evaluation is received.

The evaluation receiving unit 105 receives the evaluation of the operator 3 when the operator 3 inputs the evaluation using the input apparatus. The evaluation is the defect degree, and is performed for each molding defect type received by the information receiving unit 101. A new type of molding defect other than the received molding defect types may also occur. In addition to the evaluation of the received molding defect type, the evaluation may also combine evaluations of other types of molding defects into one. In this way, even if there is an improvement trend in the evaluation of each molding defect type, if there is a worsening trend in the evaluation of other types of molding defects, these evaluations may be reflected when determining the optimal solution. If there is a similar tendency, it is possible to take measures such as reconsidering the combination of the design variables.

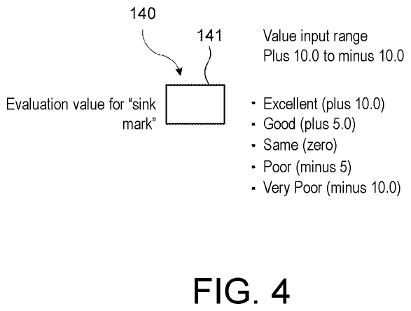

The evaluation to be received by the evaluation receiving unit 105 is, for example, zero if the second molded product 21 is the same as the first molded product in terms of defect degree for each molding defect type. When the defect degree of the second molded product 21 is less than that of the first molded product, the evaluation is good and is set to a plus value. The limit for a good evaluation is plus 10. When the defect degree of the second molded product 21 is greater than that of the first molded product, the evaluation is bad and is set to a minus value. The limit for a bad evaluation is minus 10. A numerical value between the range of minus 10 and plus 10 is input. The numerical values entered as the evaluation may be entered in increments of 1 (e.g., 0, 1, 2, etc.), 0.1 (e.g., 0.0, 0.1, 0.2, etc.), 0.01 (e.g., 0.00, 0.01, 0.02, etc.), or even smaller or larger increments within a numerical range. The numerical range or the increment width is not limited thereto, and may be designed as appropriate. The evaluation receiving unit 105 may for example, present a numerical value input field 140 on a display apparatus, such as a monitor connected to the external apparatus connection unit 14, which is a display unit not shown in the figure. FIG. 4 shows an example where the display unit presents a numerical value input field 141 for inputting the defect degree by numerical value, as the numerical value input field 140. The evaluation receiving unit 105 may receive a numerical value input to the numerical value input field 140 by the operator 3 using the input apparatus as the evaluation. The evaluation receiving unit 105 may present as many numerical value input fields 140 as the number of the received molding defect types on the display unit.

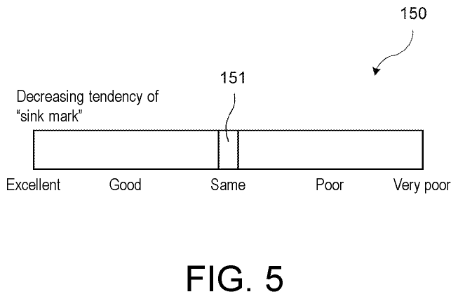

The evaluation receiving unit 105 may present a slider bar rather than the numerical value input field 140 on the display apparatus and receive the position of a slider of the slider bar as the evaluation. The slider is operated by the operator 3 using the input apparatus. As shown in FIG. 5, the slider bar 150 allows the operator 3 to input evaluation by moving the slider 151 according to the evaluation, in this way, the evaluation receiving unit 105 receives the position of the slider 151 converted into a numerical value as described above. At this time, for example, “excellent” may be displayed below the left edge of the slider bar, “same” may be displayed below the center, “very poor” may be displayed below the right edge, “good” may be displayed below the center between the left end and the center, and “bad” may be displayed below the center between the center and the right end. This allows the operator 3 to input evaluation easily. The evaluation receiving unit 105 presents a number of slider bars 150 on the display unit corresponding to a number of the molding defect types received by the information receiving unit 101. The evaluation by the operator 3 serves as an indication of whether the corresponding molding defect type have been improved, using the first molded product prototyped by the injection molding machine 2 as a reference, however, in order to be able to evaluate not merely good or bad but also the degree, the evaluation receiving unit 105 receives the evaluation for the molded product 21 after the injection molding machine 2 has initially prototyped at least three molded products 21. Preferably, the evaluation receiving unit 105 receives the evaluation for the second molded product after the injection molding machine 2 has initially prototyped three second molded product.

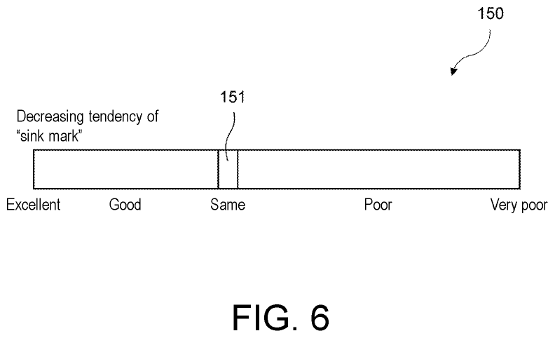

After initially receiving the evaluation, the evaluation receiving unit 105 receives the evaluation for the molded product 21 for each prototyping of the molded product 21 by the injection molding machine 2, and during this process, in the case that the best or the worst evaluation is received, that is, when the slider 151 is moved to the end of the previously presented slider bar 150, the length of the newly presented slider bar 150 is extended and a feature is provided so that the input of even better or worse evaluations is enabled, as shown in FIG. 6. FIG. 6 is a diagram showing an example of extending the length of the slider bar 150. At this time, since the moving range of the slider 151 increases, the evaluation receiving unit 105 also increases the range of the numerical value converted from the position of the slider 151.

As the evaluation to be received by the evaluation receiving unit 105, instead of the defect degree of the molding defect, the actual measured value of the molded product 21, for example, dimensions and weight, may be input as the evaluation target. As the evaluation to be received by the evaluation receiving unit 105, instead of the defect degree of the molding defect, the actual measured value of the molding defect part of the molded product 21, for example, dimensions may be input as the evaluation target. For example, dimensions include length, area, or volume. As the evaluation to be received by the evaluation receiving unit 105, instead of the defect degree of the molding defect, the number of occurrences of the same molding defect on the molded product 21 may be input as the evaluation target. Alternatively, as the evaluation to be received by the evaluation receiving unit 105, instead of the defect degree of the molding defect, the measurable measured values for both the molded product 21 and the molding defect may be input as the evaluation target.

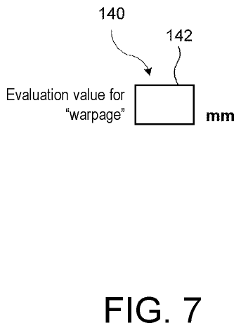

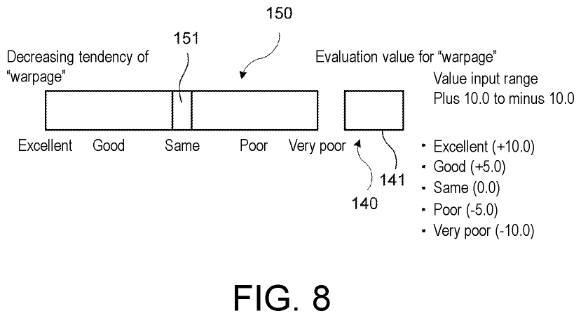

FIG. 7 shows an example in which, when the molding defect type is set as “warpage,” the numerical value input field 142 for inputting the actual measured value of the “warpage” of the molded product 21 is presented on the display unit as the numerical value input field 140 for inputting the evaluation to be received by the evaluation receiving unit 105 numerically. For one molding defect type, a numerical value input field 140 and a slider bar 150 may be displayed together on the display unit. For example, FIG. 8 shows an example in which, when the molding defect type is set as “warpage,” the slider bar 150 and numerical value input field 141 for inputting the defect degree of the “warpage” of the molded product 21 are presented together on the display unit as the evaluation to be received by the evaluation receiving unit 105. At this time, the operator 3 may input the defect degree of the “warpage” of the molded product 21 using either the slider bar 150 or the numerical value input field 141. Although not shown, for example, when the molding defect type is set as “warpage,” the slider bar 150 for inputting the defect degree of the “warpage” of the molded product 21 and the numerical value input field 142 for inputting the actual measured value of the “warpage” of the molded product 21 may be presented together on the display unit as the evaluation to be received by the evaluation receiving unit 105. At this time, the operator 3 may input both the defect degree and the actual measured value of the “warpage” of the molded product 21.

For example, operated by the operator 3 using the input apparatus to operate the end button, the evaluation receiving unit 105 may receive an evaluation indicating that for the quality of the molded product 21, which also includes the received molding defect type, the desired quality of the operator 3 is satisfied in a simple two-alternative evaluation of satisfaction or non-satisfaction. For example, when the operator 3 does not operate the end button, the evaluation receiving unit 105 may receive an evaluation indicating the defect degree, assuming that the quality of the molded product 21, including the accepted molding defect types, does not satisfy the desired quality of the operator 3.

The learned data generating unit 106 generates learned data for molding the molded product with desired quality by being reflected in the molding conditions based at least on the learning data generated by the learning data generating unit 103 and the evaluation therefor. Molding defects are factors that reduces the quality of molded products. When the quality of the molded product 21 satisfies the desired quality of the operator 3, the evaluation for the molded product 21 received by the evaluation receiving unit 105 satisfies the acceptance standard.

When the learning data for which an evaluation received by the evaluation receiving unit 105 satisfies an acceptance standard exists, the learned data generating unit 106 generates the learning data for which that evaluation satisfies the acceptance standard as the learned data. When the regenerated learning data for which an evaluation received by the evaluation receiving unit 105 satisfies an acceptance standard exists, the learned data generating unit generates the regenerated learning data for which that evaluation satisfies the acceptance standard as the learned data, even for the learning data regenerated by the learning data generating unit 103.

The learned data generating unit 106 quantifies the evaluation received by the evaluation receiving unit 105, and uses objective functions for the quantification. The objective function utilizes, for example, a function using fuzzy theory in the case that the number of defect types received by the information receiving unit 101 is one and at least one quality evaluation formula using scalarization method, etc., in the case that the number of defect types received by the information receiving unit 101 is plural. The scalarization method described above is preferably a multiplicative scalarization method. In the case that the evaluation received by the evaluation receiving unit 105 is an actual measured value, the learned data generating unit 106 may directly handle that actual measured value as the objective function value. As the objective function in this case, for example, the actual measured value is used in the case that the number of defect types received by the information receiving unit 101 is one, and the scalarization method, etc., is used in the case that the number of defect types received by the information receiving unit 101 is plural to set to at least one. Similarly, the scalarization method is preferably a multiplicative scalarization method. A multi-objective optimal design using at least two objective functions may be applied while also considering the cycle time. The multi-objective optimal design is a method for simultaneously minimizing the objective functions when multiple objective functions exist.

When determining the optimal solution, which will be described later, by applying the multi-objective optimal design using at least two objective functions, multiple optimal solutions may be determined. As multiple optimal solutions are able to be determined, the possibility of quickly discovering learned data increases. When determining the optimal solution described below, in the case that the multi-objective optimal design using at least two objectives, including an objective function related to the quality and an objective function related to the cycle time, multiple optimal solutions may be determined, while an optimal solution that takes into account not only the quality of the molded product but also the productivity of the molded product may be determined. For example, the cycle time is the sum of filling time, pressure holding time, and cooling time. The filling time is the time for filling the cavity of the metal mold apparatus with the resin material based on speed control. The pressure holding time is the time for applying pressure to the molten resin in the metal mold apparatus based on pressure control until the molten resin in the gate cools and solidifies, so as to prevent the molten resin in the metal mold apparatus from flowing back. The cooling time is the time from the end of the pressure holding until the molten resin in the metal mold apparatus cools and solidifies as a whole. The number of optimal solutions to be determined is set automatically or manually.

When the learning data for which an evaluation received by the evaluation receiving unit 105 satisfies an acceptance standard does not exist, the learned data generating unit 106 determines at least one optimal solution for the design variables using the optimization method based at least on the learning data and the evaluation.

For each design variable, one optimal solution has one optimal value, which is a candidate for the setting data to be set to a part of the molding conditions determined by the design variable determination unit 102 as the design variables. The optimal solution may be determined within the range between the upper limit value and the lower limit value of each of the design variables used when generating the learning data. The optimal solution may also be determined within a range between the upper limit value and the lower limit value that are different from either or both of the upper limit value and the lower limit value of each of design variable used when generating the learning data. The number of optimal solutions determined by the learned data generating unit 106 is preferably plural. When the optimal solution for which an evaluation received by the evaluation receiving unit satisfies an acceptance standard exists, the learned data generating unit 106 generates the optimal solution for which that evaluation satisfies the acceptance standard as the learned data.

When the learning data for which an evaluation received by the evaluation receiving unit 105 satisfies an acceptance standard does not exist, the learned data generating unit 106 redetermines at least one optimal solution for the design variables using the optimization method for the learning data regenerated by the learning data generating unit 103 based at least on the learning data generated and regenerated so far by the learning data generating unit 103, the optimal solution determined so far, and the evaluation therefor.

When the optimal solution for which an evaluation received by the evaluation receiving unit 105 satisfies an acceptance standard does not exist, the learned data generating unit 106 redetermines at least one optimal solution for the design variables using the optimization method based at least on the learning data generated so far, the optimal solution determined so far, and the evaluation therefor.

When the optimal solution for which an evaluation received by the evaluation receiving unit 105 satisfies an acceptance standard does not exist, the learned data generating unit 106 redetermines at least one optimal solution for the design variables using the optimization method based at least on the learning data generated so far, the optimal solution determined so far, and the evaluation therefor while changing the objective function used when determining the optimal solution using that optimization method.

Even when redetermining the optimal solution, for each design variable, one optimal solution has one optimal value, which is a candidate for the setting data to be set to a part of the molding conditions determined by the design variable determination unit 102 as the design variables. When redetermining the optimal solution, the optimal solution may be determined within the range between the upper limit value and the lower limit value of each of the design variables used when generating or regenerating the learning data. When redetermining the optimal solution, the optimal solution may also be determined within a range between the upper limit value and the lower limit value that are different from either or both of the upper limit value and the lower limit value of each of design variable used when generating or regenerating the learning data. The number of optimal solutions redetermined by the learned data generating unit 106 is preferably plural. When the redetermined optimal solution for which an evaluation received by the evaluation receiving unit satisfies an acceptance standard exists, the learned data generating unit 106 generates the redetermined optimal solution for which that evaluation satisfies the acceptance standard as the learned data for the redetermined optimal solution.

The determination of the optimal solution by the learned data generating unit 106 may also include the case in which an optimal solution generating unit (not shown) provided in either the injection molding assistance system 1 or the learned data generating unit 106 is used to determine the optimal solution. The redetermination of the optimal solution by the learned data generating unit 106 may also include the case in which an optimal solution generating unit (not shown) provided in either the injection molding assistance system 1 or the learned data generating unit 106 is used to redetermine the optimal solution.

As the optimization method, although various methods such as the Taguchi method and the response curved surface methodology may be used, among those methods, it is preferable to use a method that combines the RBF network and differential evolution (hereinafter referred to as DE). In the following description, an example is described in which a method combining the RBF network and DE is used.

When the learning data for which an evaluation received by the evaluation receiving unit 105 satisfies an acceptance standard does not exist, the learned data generating unit 106 generates a response curved surface using the RBF network and determines at least one optimal solution for the design variables using DE for that response curved surface based at least on the learning data and the evaluation.

When the learning data for which an evaluation received by the evaluation receiving unit 105 satisfies an acceptance standard does not exist, the learned data generating unit 106 regenerates a new response curved surface using the RBF network and redetermines at least one optimal solution for the design variables using DE for that new response curved surface based at least on the learning data generated and regenerated so far by the learning data generating unit 103, the optimal solution determined so far, and the evaluation therefor, for the learning data regenerated by the learning data generating unit 103.

When the optimal solution for which an evaluation received by the evaluation receiving unit 105 satisfies an acceptance standard does not exist, the learned data generating unit 106 regenerates a new response curved surface using the RBF network and redetermines at least one optimal solution for the design variables using DE for that new response curved surface based at least on the learning data generated so far, the optimal solution determined so far, and the evaluation therefor.

When the optimal solution for which an evaluation received by the evaluation receiving unit 105 satisfies an acceptance standard does not exist, the learned data generating unit 106 regenerates a new response curved surface using the RBF network and redetermines at least one optimal solution for the design variables using DE for that new response curved surface based at least on the learning data generated so far, the optimal solution determined so far, and the evaluation therefor while changing the objective function used when determining the optimal solution.

The RBF network is a method of creating a response curved surface and approximating the relationship between the design variables and the objective functions based on the evaluated learning data. The RBF network is a feedforward type neural network consisting of three layers: an input layer, an intermediate layer, and an output layer, and a Gaussian function is used as the basis function used in the intermediate layer. When this RBF network is used, the output layer corresponds to an approximate expression (response curved surface) expressing the relationship between the design variables and the objective functions values. By evaluating the learning data, the correspondence between the input and the output is understood, and by using this to determine the unknown parameters in the approximate expression, approximate expressions may be created and the optimal solution may be determined. In the RBF network, it is possible to easily perform successive approximation optimization that adds learning data in stages, and it is possible to obtain a highly accurate optimal solution with a small amount of learning data. This increases the possibility of quickly discovering learned data.

DE is a method of determining an optimal solution for a response curved surface created using the RBF network. The design variable is a continuous value, and since the relational expression between the objective functions and the design variables is expected to be a complex expression with strong nonlinearity, using metaheuristics is more likely to arrive at a satisfactory optimal solution than using nonlinear programming. DE is a type of genetic algorithm that mimics biological evolution, and is also a metaheuristic that does not use a gradient of function. This algorithm is an algorithm for determining an optimal solution of an approximate function. The metaheuristic does not use the gradient of function and is a method of determining an optimal solution from only the function value, which is an algorithm created based on analogies in physical phenomena, life/biological phenomena, social phenomena, etc. Nonlinear programming is a method of determining an optimal solution using the gradient of function. “Determine an optimal solution” may be rephrased as “generate an optimal solution.”

Satisfying an acceptance standard means, for example, for the quality of the second molded product, which also includes the received molding defect type, an evaluation of “satisfaction” of the desired quality of the operator 3 when an evaluation of a simple two-alternative evaluation of satisfaction or non-satisfaction is included in the evaluation received by the evaluation receiving unit 105.

Satisfying an acceptance standard means, for example, that as an evaluation received by the evaluation receiving unit 105, when the evaluation for each molding defect type indicates the defect degree or the actual measured value of each molding defect numerically, each numerical value indicating each evaluation for all molding defect types is a numerical value indicating the side of improvement for each molding defect with respect to the predetermined threshold value.

Satisfying an acceptance standard means, for example, that as an evaluation received by the evaluation receiving unit 105, when the evaluation for each molding defect type indicates the defect degree or the actual measured value of each molding defect numerically, an acceptable range indicating improvement for each molding defect type is predetermined for all molding defect types, and the numerical value indicating each evaluation is within each acceptable range.

Satisfying an acceptance standard means, for example, that when an evaluation that combines evaluations for different types of molding defects that have occurred in addition to the received molding defect types into one is included in the evaluation received by the evaluation receiving unit 105, similar to the evaluation for each molding defect type, acceptance determination is also performed on that evaluation using a predetermined threshold value or an acceptable range, and that evaluation and all evaluations for each molding defect type satisfy the acceptance standard.

In addition, the evaluation received by the evaluation receiving unit 105 is quantified using the objective functions or the quality evaluation formula, and it is determined whether or not that quantified evaluation satisfies the acceptance standard. Since the evaluation input by the operator 3 is a relative value and ambiguous if it is simply converted to a parameter value corresponding to the position of the scroll bar, the quantification is performed using fuzzy theory. In this case as well, a predetermined threshold value or an acceptable range is used for the acceptance standard.

### 3. Operation of Injection Molding Assistance System 1

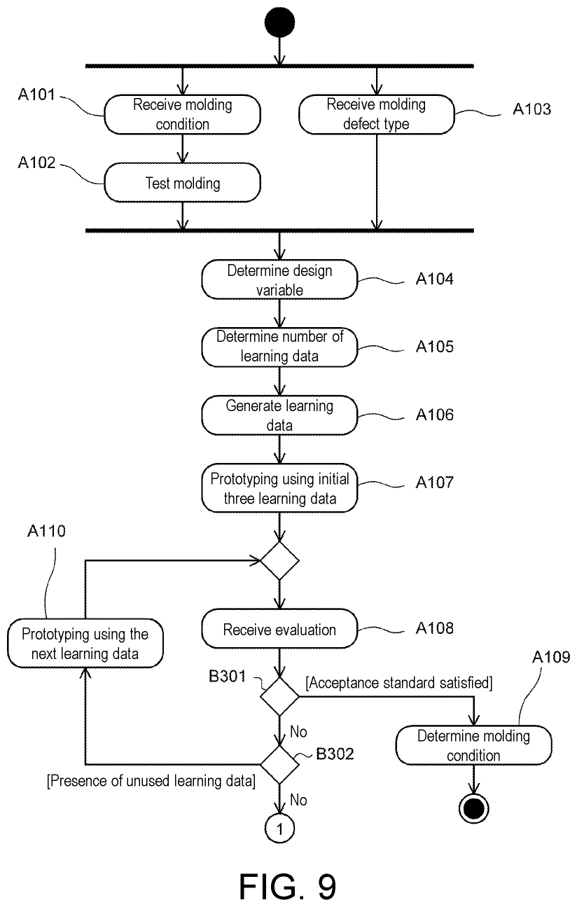

Referring to the activity diagrams in FIGS. 9, 10, 11, 12 and 13, using the injection molding assistance system 1, the method for generating the learned data for determining the molding conditions is described. Various information, various conditions, various data, etc., input by the operator 3 are stored in the storage unit 12 or the temporary storage unit 13 and read from the storage unit 12 or the temporary storage unit 13 as necessary. Various information, various conditions, and various data, etc., generated or calculated by each part of the injection molding assistance system 1, are stored in the storage unit 12 or the temporary storage unit 13 and read from the storage unit 12 or the temporary storage unit 13 as necessary. The learning data and the optimal solution are stored in the storage unit 12 or the temporary storage unit 13 and read from the storage unit 12 or the temporary storage unit 13 as necessary. The evaluation received by the evaluation receiving unit 105 is stored in the storage unit 12 or the temporary storage unit 13 in association with the learning data and optimal solution corresponding to that evaluation and read from the storage unit 12 or the temporary storage unit 13 as necessary. The learning data, the optimal solution, and the corresponding evaluation are stored in the storage unit 12 in the form of a data base such as a table and read from the storage unit 12 as necessary. The acceptance standard may be stored in the storage unit 12 or the temporary storage unit 13 in advance and read from the storage unit 12 or the temporary storage unit 13 as necessary.

As shown in FIG. 9, the operator 3 inputs the trial molding conditions, and the information receiving unit 101 receives the trial molding conditions in A101. The trial molding conditions may be determined using, for example, the apparatus described in Patent Document 1 or Patent Document 2 by the operator 3. The operator 3 may input the molding conditions by reading the trial molding conditions stored in the storage unit 12. In A102, the molding control unit 104 causes the injection molding machine 2 to perform test molding based on the trial molding conditions. The first molded product prototyped by the test molding may be used as a reference during the evaluation. After A101 and A102, or in parallel with these actions, the information receiving unit 101 receives the article information and the molding defect types in A103.

In A104, the design variable determination unit 102 determines at least one molding condition that is a learning object among the molding conditions as the design variable based on the article information and the molding defect types. The learning data generating unit 103 determines the required number of learning data in A105 and generates the determined number of learning data in A106. The number of learning data is a predetermined number corresponding to the number of design variables. The molding defect types used to determine the design variables may be one or a combination of two or more.

In A107, the molding control unit 104 causes the injection molding machine 2 to sequentially prototype three second molded products with different molding conditions according to three molding conditions that reflect the initial three learning data, respectively. Starting from the first learning data, the data of each design variable is sequentially set as the setting data of the corresponding molding condition, respectively, and the injection molding machine 2 is caused to sequentially prototype three second molded products with different molding conditions with the molding conditions combined with the setting data of other molding conditions that are not selected as the design variables in the trial molding conditions. The operator 3 performs evaluation by comparing three second molded products, and in A108, the evaluation receiving unit 105 receives evaluations from the operator 3 for the three second molded products, respectively.

For example, the operator 3 operates the position of the slider 151 of the slider bar 150 displayed on the display apparatus to evaluate the second molded product in terms of the molding defect types. For example, in the case that the molding defect type is sink mark and three second molded products are prototyped, the operator 3 compares the states of the sink marks of the three second molded products and ranks the performance of the three second molded products in terms of sink marks. The operator 3 operates the position of the slider 151 of the slider bar 150 shown in FIG. 5 to input the evaluation for the sink mark of each second molded product. When other molding defect types are additionally selected, for example, warpage, the evaluation is input by operating the slider 151 of the slider bar 150, which is displayed separately in the same way as for the sink mark.

According to the evaluation that satisfies the acceptance standard, the method branches at block B301 following A108. When the three evaluations received by the evaluation receiving unit 105 include an evaluation that satisfies the acceptance standard, the method proceeds to A109. In A109, the learned data generating unit 106 generates the learning data used when prototyping the second molded product for which the evaluation satisfies the acceptance standard as the learned data. The learned data generating unit 106 determines the molding conditions that reflect the learned data as the final molding conditions to be used to generate the third molded product. The learned data generating unit 106 sets the data of each design variable of the learned data as the setting data of the corresponding molding condition. The setting data of other molding conditions that are not selected as the design variables in the trial molding conditions is input to determine the final molding conditions. Molding is performed under the final molding conditions to generate the planned number of third molded products.

When the three evaluations received by the evaluation receiving unit 105 in block B301 do not include an evaluation that satisfies the acceptance standard, the method proceeds to block B302. According to the unused learning data, the method branches at block B302. In the presence of unused learning data, the molding control unit 104 causes the injection molding machine 2 to prototype a second molded product using the molding conditions that reflect the next learning data in A110. Following A110, the method returns to A108.

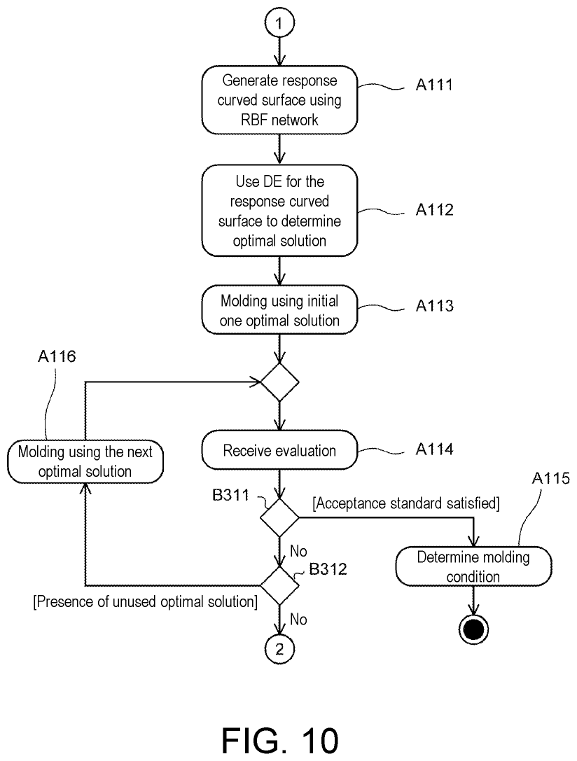

In the case that all learning data has been used in block B302, the method proceeds to A111 in FIG. 10. Here, the learned data generating unit 106 generates a response curved surface using the RBF network based at least on all the learning data and the corresponding evaluations thereof. Next, in A112, the learned data generating unit 106 uses DE for that created response curved surface to determine at least one optimal solution for the design variables. Here, multiple optimal solutions may be determined. When multiple types of design variables are determined in the design variable determination unit 102, one optimal solution is composed of multiple types of design variables. The combination of design variables of the optimal solution is the same as the combination of design variables of the learning data.

In A113, the molding control unit 104 causes the injection molding machine 2 to prototype a second molded product according to one molding condition that reflects one optimal solution. The data of each design variable is set as the setting data of the corresponding molding condition. The setting data of other molding conditions that are not selected as the design variables in the trial molding conditions is also input. In this way, the injection molding machine 2 is caused to prototype a second molded product under the trial molding conditions. The operator 3 performs evaluation while looking at the second molded products, and in A114, the evaluation receiving unit 105 receives the evaluation for the second molded product by the operator 3.

According to the evaluation that satisfies the acceptance standard, the method branches at block B311 following A114. When the evaluation received by the evaluation receiving unit 105 satisfies the acceptance standard, the method proceeds to A115. In A115, the learned data generating unit 106 generates the optimal solution corresponding to that evaluation as the learned data and set the molding conditions that reflect the generated learned data as the molding conditions of the third molded product. The learned data generating unit 106 is input with the setting data of the molding condition corresponding to the data of each design variable of the optimal solution. The setting data of other molding conditions that are not selected as the design variables in the trial molding conditions is also input. In this way, the final molding conditions for producing the third molded product is determined. Molding is performed under the final molding conditions to generate the planned number of third molded products.

When the evaluation received by the evaluation receiving unit 105 in block B311 does not satisfy the acceptance standard, the method proceeds to block B312. According to the unused optimal solution, the method branches at block B312. In the presence of unused optimal solution, the molding control unit 104 causes the injection molding machine 2 to prototype a second molded product using the molding conditions that reflects the next optimal solution in A116. Following A116, the method returns to A114.

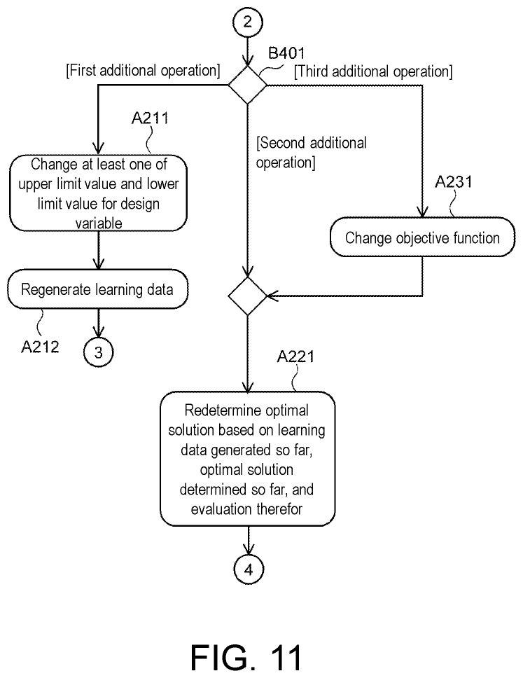

In the case that all optimal solutions have been used in block B312, the method proceeds to block B401 in FIG. 11. According to the additional operation, the method branches at block B401. When the evaluation does not satisfy the acceptance standard in blocks B301 and B311, at least one of three additional operations may be performed. By doing so, the possibility of quickly discovering learned data is increased. At least two of the three additional operations may be performed in a determined order. Each of the three additional operations may be performed consecutively.

When the first additional operation is selected in block B401, at least one of the upper limit value and the lower limit value for each design variable is changed as necessary in A211. The details are as shown in the following example. The learning data generating unit 103 generates learning data within the range of the upper limit value and the lower limit value for each design variable. For each design variable, the learning data generating unit 103 increases at least the upper limit value to greater than the upper limit value used last time when a difference between the numerical value of the determined optimal solution and the upper limit value used last time is less than a predetermined value, and decreases at least the lower limit value to less than the lower limit value used last time when a difference between the numerical value of the determined optimal solution and the lower limit value used last time is less than a predetermined value.

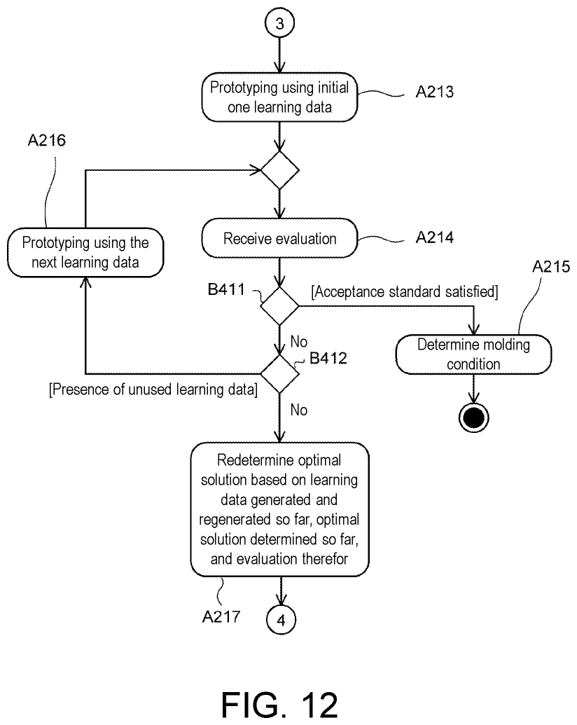

Next, in A212, multiple learning data are regenerated. In A213 in FIG. 12, the molding control unit 104 causes the injection molding machine 2 to prototype a second molded product according to the molding conditions that reflect the initially regenerated learning data. In A214, the evaluation receiving unit 105 receives an evaluation for the second molded product. According to the evaluation that satisfies the acceptance standard, the method branches at block B411 following A214. When the evaluation received by the evaluation receiving unit 105 satisfies the acceptance standard, the method proceeds to A215. In A215, the learned data generating unit 106 generates the regenerated learning data corresponding to that evaluation as the learned data. The learned data generating unit 106 determines the molding conditions that reflect the generated learned data as the final molding conditions to be used to generate the third molded product. Molding is performed under the final molding conditions to generate the planned number of third molded products.

When the evaluations received by the evaluation receiving unit 105 in block B411 do not include an evaluation that satisfies the acceptance standard, the method proceeds to block B412. According to the unused learning data, the method branches at block B412. In the presence of unused learning data, the molding control unit 104 causes the injection molding machine 2 to prototype the next second molded product using the molding conditions that reflect the regenerated next learning data in A216. Following A216, the method returns to A214.

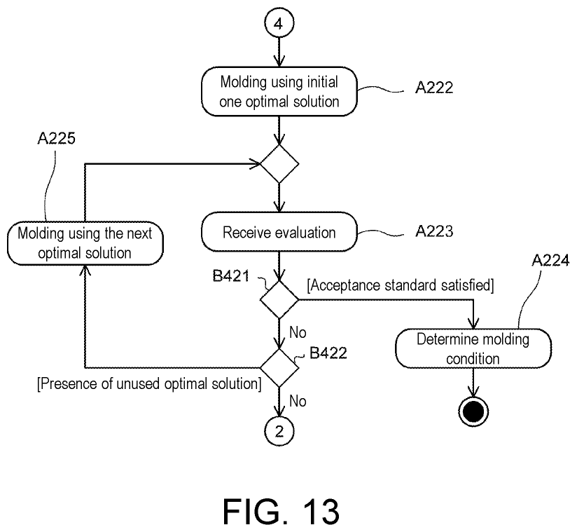

When the evaluation in block B412 do not satisfy the acceptance standard, the method proceeds to A217. In A217, at least one optimal solution is redetermined based at least on the learning data generated and regenerated so far, the optimal solution determined so far, and the evaluation therefor. At this time, it is preferable to redetermine multiple optimal solutions. In A222 in FIG. 13 following A217, the molding control unit 104 causes the injection molding machine 2 to prototype a second molded product according to one molding condition that reflects one initial optimal solution. The operator 3 evaluates the second molded product, and in A223, the evaluation receiving unit 105 receives the evaluation for the second molded product by the operator 3.

According to the evaluation that satisfies the acceptance standard, the method branches at block B421 following A223. When the evaluation satisfies the acceptance standard, the method proceeds to A224. In A224, the learned data generating unit 106 generates the optimal solution corresponding to that evaluation as the learned data and set the molding conditions that reflect the generated learned data as the molding conditions of the third molded product.

When the evaluation in block B421 satisfy the acceptance standard, the method proceeds to block B422. According to the unused optimal solution, the method branches at block B422. In the presence of unused optimal solution, the molding control unit 104 causes the injection molding machine 2 to prototype a second molded product using the molding conditions that reflect the next optimal solution in A225. Following A225, the method returns to A223.

When the second additional operation is selected in block A401 in FIG. 11, in A221, at least one optimal solution is redetermined based at least on the learning data generated so far, the optimal solution determined so far, and the evaluation therefor. The details are as shown in the following example. The learned data generating unit 106 regenerates a new response curved surface using the RBF network and redetermines multiple optimal solutions for the design variables using DE for that new response curved surface based at least on the learning data generated so far by the learning data generating unit, the optimal solution determined so far, and the evaluation therefor.

Following A221, the method proceeds to A222 in FIG. 13. When the third additional operation is selected in block B401 in FIG. 11, the objective function is to be changed in A231. The details are as shown in the following example. The third additional operation is performed when there are two or more molding defect types. In the case that one quality evaluation formula formulated using the scalarization method, etc., is used as one objective function for two or more molding defect types when determining the optimal solution the last time, an individual objective function is used for each molding defect type when the optimal solution is redetermined this time, and vice versa. Each individual objective function is formulated using, for example, fuzzy theory. The scalarization method is preferably a multiplicative scalarization method. Following A231, the method proceeds to A221.

### 4. Others

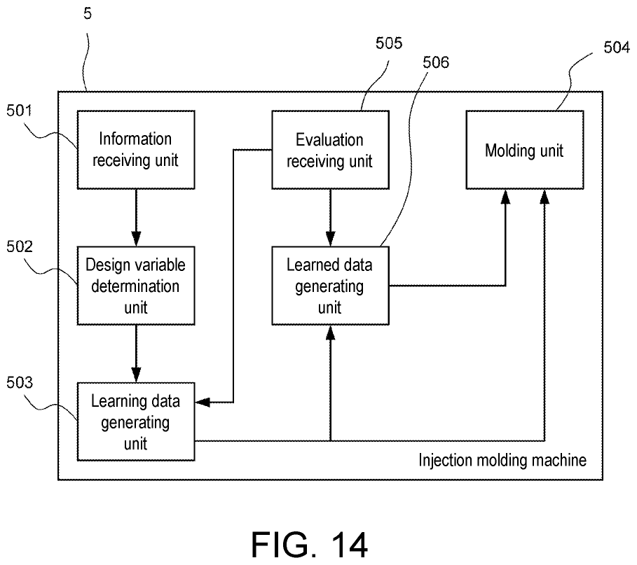

The injection molding assistance system 1 described above may also be incorporated into an injection molding machine. As shown in FIG. 14, the injection molding machine 5 being controlled according to the molding conditions includes: an information receiving unit 501, receiving molding conditions, article information, and molding defect types; a design variable determination unit 502, determining a part of molding conditions to be learned among the molding conditions as design variables based on the article information and the molding defect types; a learning data generating unit 503, generating multiple learning data in which the design variables are uniformly distributed in a variable space constituted by the design variables; a molding unit 504, prototyping a molded product according to the molding conditions that reflect the learning data; an evaluation receiving unit 505, receiving an evaluation for the molded product; and a learned data generating unit 506, generating learned data for molding the molded product with desired quality by being reflected in the molding conditions based at least on the learning data and the evaluation. The molding unit 504 is, for example, an injection apparatus and a mold clamping apparatus (not shown) provided in the injection molding machine 5.

The information receiving unit 501, the design variable determination unit 502, the learning data generating unit 503, the evaluation receiving unit 505, and the learned data generating unit 506 respectively corresponds to the information receiving unit 101, the design variable determination unit 102, the learning data generating unit 103, the evaluation receiving unit 105, and the learned data generating unit 106, and the molding unit 504 is equivalent to that combined by the molding control unit 104 and the injection molding machine 2.

The injection molding assistance method to be performed by the injection molding assistance system 1 and the injection molding machine 5 is an injection molding assistance method for an injection molding machine controlled according to molding conditions, and includes a step of receiving molding conditions, article information, and molding defect types; a step of determining a part of molding conditions to be learned among the molding conditions as design variables based on the article information and the molding defect types; a step of generating multiple learning data in which the design variables are uniformly distributed in a variable space constituted by the design variables; a step of causing the injection molding machine to mold a molded product according to the molding conditions that reflect the learning data; a step of receiving an evaluation for the molded product; and a step of generating learned data for molding a molded product with desired quality by being reflected in the molding conditions based at least on the learning data and the evaluation.

Although various embodiments of the present invention have been described, these embodiments are mere examples and are not intended to limit the scope of the invention. Novel embodiments may be implemented in various other forms, and various omissions, replacements, and changes may be made without departing from the gist of the invention. These embodiments and modifications thereof are encompassed in the scope and gist of the present invention, and are also encompassed in the scope of the invention described in the claims and equivalents thereof.

What is claimed is:

1. An injection molding assistance system for an injection molding machine controlled according to set molding conditions, comprising:
an information receiving unit, receiving trial molding conditions, article information, and molding defect types;
a design variable determination unit, determining a part of molding conditions to be learned as design variables based on the article information and the molding defect types;
a learning data generating unit, generating a plurality of learning data in which the design variables are uniformly distributed in a variable space constituted by the design variables;
a molding control unit, causing the injection molding machine to prototype a molded product according to the trial molding conditions that reflect the learning data;
an evaluation receiving unit, receiving an evaluation for the molded product; and
a learned data generating unit, generating learned data for molding an article with desired quality by being reflected in the trial molding conditions based at least on the learning data and the evaluation.

2. The injection molding assistance system according to claim 1, wherein the evaluation receiving unit receives an evaluation for the molded product after the injection molding machine has prototyped a predetermined number of molded products.

3. The injection molding assistance system according to claim 2, wherein the molding control unit causes the injection molding machine to prototype a first molded product according to the trial molding conditions received by the information receiving unit and causes the injection molding machine to prototype a second molded product according to the trial molding conditions that reflect the learning data, and
the evaluation receiving unit receives an evaluation for the molded product after the injection molding machine has prototype at least three second molded product.

4. The injection molding assistance system according to claim 2, wherein the evaluation receiving unit receives an evaluation for the molded product each time the injection molding machine prototypes a molded product after an evaluation is received initially.

5. The injection molding assistance system according to claim 1, wherein the evaluation receiving unit presents a slider bar and receives a position of a slider of the slider bar as the evaluation.

6. The injection molding assistance system according to claim 5, wherein the evaluation receiving unit presents a number of slider bars corresponding to a number of the molding defect types received by the information receiving unit.

7. The injection molding assistance system according to claim 5, wherein the evaluation receiving unit extends a length of a newly presented slider bar when a slider is moved to an end of a previously presented slider bar.

8. The injection molding assistance system according to claim 1, wherein the evaluation receiving unit presents a numerical value input field and receives a numerical value input to the numerical value input field as an evaluation.

9. The injection molding assistance system according to claim 8, wherein the evaluation receiving unit presents a number of numerical value input fields corresponding to a number of the molding defect types received by the information receiving unit.

10. The injection molding assistance system according to claim 1, wherein when the learning data for which an evaluation received by the evaluation receiving unit satisfies an acceptance standard exists, the learned data generating unit generates the learning data for which the evaluation satisfies the acceptance standard as the learned data.

11. The injection molding assistance system according to claim 1, wherein when the learning data for which an evaluation received by the evaluation receiving unit satisfies an acceptance standard does not exist, the learned data generating unit determines at least one optimal solution for the design variables based at least on the learning data and the evaluation,
the molding control unit causes the injection molding machine to prototype a molded product according to the trial molding conditions that reflect the optimal solution,
the evaluation receiving unit receives an evaluation for the molded product, and
when the optimal solution for which an evaluation received by the evaluation receiving unit satisfies an acceptance standard exists, the learned data generating unit further generates the optimal solution for which the evaluation satisfies the acceptance standard as the learned data.

12. The injection molding assistance system according to claim 11, wherein the learning data generating unit generates the learning data within a range of an upper limit value and a lower limit value of the design variables,
increases at least the upper limit value and regenerates a plurality of the learning data when the optimal solution for which an evaluation received by the evaluation receiving unit satisfies an acceptance standard does not exist and a difference between the optimal solution and the upper limit value is less than a predetermined value, and
decreases at least the lower limit value and regenerates a plurality of the learning data when the optimal solution for which an evaluation received by the evaluation receiving unit satisfies an acceptance standard does not exist and a difference between the optimal solution and the lower limit value is less than a predetermined value,
the molding control unit causes the injection molding machine to prototype a molded product according to the trial molding conditions that reflect the learning data regenerated by the learning data generating unit,
the evaluation receiving unit receives an evaluation for the molded product, and
when the regenerated learning data for which an evaluation received by the evaluation receiving unit satisfies an acceptance standard exists, the learned data generating unit generates the regenerated learning data for which the evaluation satisfies the acceptance standard as the learned data.

13. The injection molding assistance system according to claim 12, wherein when the regenerated learning data for which an evaluation received by the evaluation receiving unit satisfies an acceptance standard does not exist, the learned data generating unit redetermines at least one optimal solution for the design variables based at least on the learning data generated and regenerated so far by the learning data generating unit, the optimal solution, and the evaluation for the learning data and the optimal solution,
the molding control unit causes the injection molding machine to prototype a molded product according to the trial molding conditions that reflect the redetermined optimal solution,
the evaluation receiving unit receives an evaluation for the molded product, and
when the redetermined optimal solution for which an evaluation received by the evaluation receiving unit satisfies an acceptance standard exists, the learned data generating unit further generates the redetermined optimal solution for which the evaluation satisfies the acceptance standard as the learned data.

14. The injection molding assistance system according to claim 11, wherein when the optimal solution for which an evaluation received by the evaluation receiving unit satisfies an acceptance standard does not exist, the learned data generating unit redetermines at least one optimal solution for the design variables based at least on the learning data, the optimal solution, and the evaluation for the learning data and the optimal solution,
the molding control unit causes the injection molding machine to prototype a molded product according to the trial molding conditions that reflect the redetermined optimal solution,
the evaluation receiving unit receives an evaluation for the molded product, and
when the redetermined optimal solution for which an evaluation received by the evaluation receiving unit satisfies an acceptance standard exists, the learned data generating unit further generates the redetermined optimal solution for which the evaluation satisfies the acceptance standard as the learned data.

15. The injection molding assistance system according to claim 11, wherein when the optimal solution for which an evaluation received by the evaluation receiving unit satisfies an acceptance standard does not exist, the learned data generating unit redetermines at least one optimal solution for the design variables based at least on the learning data, the optimal solution, and the evaluation for the learning data and the optimal solution while changing an objective function used when determining the optimal solution,
the molding control unit causes the injection molding machine to prototype a molded product according to the trial molding conditions that reflect the redetermined optimal solution,
the evaluation receiving unit receives an evaluation for the molded product, and
when the redetermined optimal solution for which an evaluation received by the evaluation receiving unit satisfies an acceptance standard exists, the learned data generating unit further generates the redetermined optimal solution for which the evaluation satisfies the acceptance standard as the learned data.

16. An injection molding assistance method for an injection molding machine controlled according to set molding conditions, comprising:
a step of receiving trial molding conditions, article information, and molding defect types;
a step of determining a part of molding conditions to be learned as design variables based on the article information and the molding defect types;
a step of generating a plurality of learning data in which the design variables are uniformly distributed in a variable space constituted by the design variables;
a step of causing the injection molding machine to prototype a molded product according to the trial molding conditions that reflect the learning data;
a step of receiving an evaluation for the molded product; and
a step of generating learned data for molding a molded product with desired quality by being reflected in the molding conditions based at least on the learning data and the evaluation.

17. An injection molding machine controlled according to molding conditions, comprising:
an information receiving unit, receiving trial molding conditions, article information, and molding defect types;
a design variable determination unit, determining a part of molding conditions to be learned among the molding conditions as design variables based on the article information and the molding defect types;
a learning data generating unit, generating a plurality of learning data in which the design variables are uniformly distributed in a variable space constituted by the design variables;
a molding unit, prototyping a molded product according to molding conditions obtained by reflecting the learning data in the trial molding conditions;
an evaluation receiving unit, receiving an evaluation for the molded product; and
a learned data generating unit, generating learned data for molding an article with desired quality by being reflected in the trial molding conditions based at least on the learning data and the evaluation.

18. A recording medium, storing a program that operates a computer as an injection molding assistance system,
wherein the program causes the computer to function as the injection molding assistance system according to claim 1.
